(19) United States
(12) Patent Application Publication
(10) Pub. No.: US 2015/0193721 A1
(43) Pub. Date: Jul. 9, 2015

(54) TRACKING PROCESSING OF EXCEPTIONS TO STRAIGHT-THROUGH PROCESSING PROCEDURES

(71) Applicant: Bank of America Corporation, Charlotte, NC (US)

(72) Inventors: Jayvie A. Silvestre, Manila (PH); Emma Jane B. Castro, Manila (PH)

(73) Assignee: Bank of America Corporation, Charlotte, NC (US)

(21) Appl. No.: 14/149,893

(22) Filed: Jan. 8, 2014

(51) Int. Cl. G06Q 10/06

(52) U.S. Cl. CPC G06Q 10/063114; G06Q 40/02

(57) ABSTRACT

A record corresponding to a commercial financial transaction that involves an exception to a straight-through processing procedure of a financial institution may be identified. A graphical user interface for the commercial financial transaction may be generated. The graphical user interface may comprise data from a plurality of fields of the record and one or more graphical user interface elements for controlling a timer configured to track an amount of time expended by an associate of the financial institution to process the commercial financial transaction that involves the exception to the straight-through processing procedure of the financial institution. An associate of the financial institution to process the commercial financial transaction may be identified, and the graphical user interface for the commercial financial transaction may be communicated to a computing device associated with the associate of the financial institution.

### BACKGROUND

Many organizations have developed straight-through processing procedures (e.g., procedures that require no or minimal human intervention) for processing routine transactions. Such straight-through processing procedures can increase an organization's efficiency in processing what are often large volumes of routine transactions; however, transactions that involve exceptions to such straight-through processing procedures inevitably occur. When they arise, these exception transactions may consume valuable human resources that might otherwise be expended adding value to other aspects of the transaction or within other areas of the organization. Accordingly, a need exists for tracking processing of exceptions to straight-through processing procedures.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a record corresponding to a commercial financial transaction that involves an exception to a straight-through processing procedure of a financial institution may be identified by a computing platform from amongst a plurality of records stored in a memory of the computing platform that correspond to commercial financial transactions that involve exceptions to a straight-through processing procedure of the financial institution. A graphical user interface for the commercial financial transaction that involves the exception to the straight-through processing procedure of the financial institution may be generated by the computing platform. The graphical user interface may comprise data from a plurality of fields of the record corresponding to the commercial financial transaction that involves the exception to the straight-through processing procedure of the financial institution and one or more graphical user interface elements for controlling a timer configured to track an amount of time expended by an associate of the financial institution to process the commercial financial transaction that involves the exception to the straight-through processing procedure of the financial institution. An associate of the financial institution to process the commercial financial transaction that involves the exception to the straight-through processing procedure of the financial institution may be identified by the computing platform. The graphical user interface for the commercial financial transaction that involves the exception to the straight-through processing procedure of the financial institution may be communicated by the computing platform to a computing device associated with the associate of the financial institution.

In some embodiments, the computing device associated with the associate of the financial institution may receive the graphical user interface for the commercial financial transaction that involves the exception to the straight-through processing procedure of the financial institution from the computing platform and may render the graphical user interface for the commercial financial transaction that involves the exception to the straight-through processing procedure of the financial institution. Responsive to a graphical user interface element of the one or more graphical user interface elements for controlling the timer configured to track the amount of time expended by the associate of the financial institution to process the commercial financial transaction that involves the exception to the straight-through processing procedure of the financial institution being invoked, the computing device associated with the associate of the financial institution may generate a message comprising information indicating the amount of time expended by the associate of the financial institution to process the commercial financial transaction that involves the exception to the straight-through processing procedure of the financial institution and may communicate the message comprising the information indicating the amount of time expended by the associate of the financial institution to process the commercial financial transaction that involves the exception to the straight-through processing procedure of the financial institution to the computing platform.

In some embodiments, the graphical user interface element of the one or more graphical user interface elements for controlling the timer configured to track the amount of time expended by the associate of the financial institution to process the commercial financial transaction that involves the exception to the straight-through processing procedure of the financial institution may comprise a graphical user interface element visibly labeled as being configured for controlling the timer configured to track the amount of time expended by the associate of the financial institution to process the commercial financial transaction that involves the exception to the straight-through processing procedure of the financial institution. In other embodiments, the graphical user interface element of the one or more graphical user interface elements for controlling the timer configured to track the amount of time expended by the associate of the financial institution to process the commercial financial transaction that involves the exception to the straight-through processing procedure of the financial institution may comprise a graphical user interface element associated with processing the commercial financial transaction that involves the exception to the straight-through processing procedure of the financial institution and that is not visibly labeled as being configured for controlling the timer configured to track the amount of time expended by the associate of the financial institution to process the commercial financial transaction that involves the exception to the straight-through processing procedure of the financial institution.

In some embodiments, the message comprising the information indicating the amount of time expended by the associate of the financial institution to process the commercial financial transaction that involves the exception to the straight-through processing procedure of the financial institution may be received by the computing platform from the computing device associated with the associate of the financial institution. The record corresponding to the commercial financial transaction that involves the exception to the straight-through processing procedure of the financial institution may be identified by the computing platform from amongst the plurality of records stored in the memory that correspond to commercial financial transactions that involve exceptions to a straight-through processing procedure of the financial institution. The computing platform may utilize the information indicating the amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution to process the commercial financial transaction that involves the exception to the straight-through processing procedure of the financial institution.

In some embodiments, the computing platform may receive a request to update the record corresponding to the commercial financial transaction that involves the exception to the straight-through processing procedure of the financial institution from the computing device associated with the associate of the financial institution. Responsive to receiving the request to update the record corresponding to the commercial financial transaction that involves the exception to the straight-through processing procedure of the financial institution, the computing platform may generate a graphical user interface for updating the record corresponding to the commercial financial transaction that involves the exception to the straight-through processing procedure of the financial institution and may communicate the graphical user interface for updating the record corresponding to the commercial financial transaction that involves the exception to the straight-through processing procedure of the financial institution to the computing device associated with the associate of the financial institution. The graphical user interface for updating the record may comprise data from a plurality of fields of the record corresponding to the commercial financial transaction that involves the exception to the straight-through processing procedure of the financial institution, the amount of time expended by the associate of the financial institution to process the commercial financial transaction that involves the exception to the straight-through processing procedure of the financial institution, and one or more graphical user interface elements for controlling a timer configured to track an additional amount of time expended by an associate of the financial institution to process the commercial financial transaction that involves the exception to the straight-through processing procedure of the financial institution.

In some embodiments, the computing device associated with the associate of the financial institution may receive the graphical user interface for updating the record corresponding to the commercial financial transaction that involves the exception to the straight-through processing procedure of the financial institution from the computing platform, and may render the graphical user interface for updating the record corresponding to the commercial financial transaction that involves the exception to the straight-through processing procedure of the financial institution. Responsive to a graphical user interface element of the one or more graphical user interface elements for controlling the timer configured to track the additional amount of time expended by the associate of the financial institution to process the commercial financial transaction that involves the exception to the straight-through processing procedure of the financial institution being invoked, the computing device associated with the associate of the financial institution may generate a message comprising information indicating the additional amount of time expended by the associate of the financial institution to process the commercial financial transaction that involves the exception to the straight-through processing procedure of the financial institution and may communicate the message comprising the information indicating the additional amount of time expended by the associate of the financial institution to process the commercial financial transaction that involves the exception to the straight-through processing procedure of the financial institution to the computing platform.

In some embodiments, the computing platform may receive the message comprising the information indicating the additional amount of time expended by the associate of the financial institution to process the commercial financial transaction that involves the exception to the straight-through processing procedure of the financial institution from the computing device associated with the associate of the financial institution. The computing platform may identify the record corresponding to the commercial financial transaction that involves the exception to the straight-through processing procedure of the financial institution from amongst the plurality of records stored in the memory that correspond to commercial financial transactions that involve exceptions to a straight-through processing procedure of the financial institution. The computing platform may utilize the information indicating the additional amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the additional amount of time expended by the associate of the financial institution to process the commercial financial transaction that involves the exception to the straight-through processing procedure of the financial institution.

In some embodiments, the computing platform may determine a geographic region associated with the commercial financial transaction that involves the exception to the straight-through processing procedure of the financial institution, and may populate, based on the geographic region associated with the commercial financial transaction that involves the exception to the straight-through processing procedure of the financial institution, at least a portion of the plurality of fields of the record corresponding to the commercial financial transaction that involves the exception to the straight-through processing procedure of the financial institution.

In some embodiments, the exception to the straight-through processing procedure of the financial institution may comprise a determination that an account of the financial institution associated with the commercial financial transaction that involves the exception to the straight-through processing procedure of the financial institution does not have adequate funds to complete the commercial financial transaction that involves the exception to the straight-through processing procedure of the financial institution. In such embodiments, the amount of time expended by the associate of the financial institution to process the commercial financial transaction that involves the exception to the straight-through processing procedure of the financial institution may comprise time expended by the associate of the financial institution to arrange for the adequate funds to complete the commercial financial transaction that involves the exception to the straight-through processing procedure of the financial institution to be transferred from another account of the financial institution. Additionally or alternatively, the amount of time expended by the associate of the financial institution to process the commercial financial transaction that involves the exception to the straight-through processing procedure of the financial institution may comprise time expended by the associate of the financial institution to delay processing of the commercial financial transaction that involves the exception to the straight-through processing procedure of the financial institution until one or more outstanding deposits that would provide the adequate funds to complete the commercial financial transaction that involves the exception to the straight-through processing procedure of the financial institution have been deposited in the account of the financial institution associated with the commercial financial transaction that involves the exception to the straight-through processing procedure of the financial institution.

In some embodiments, the exception to the straight-through processing procedure of the financial institution may comprise a determination that one or more items of information associated with the commercial financial transaction that involves the exception to the straight-through processing procedure of the financial institution require manual verification to complete the commercial financial transaction that involves the exception to the straight-through processing procedure of the financial institution. In such embodiments, the amount of time expended by the associate of the financial institution to process the commercial financial transaction that involves the exception to the straight-through processing procedure of the financial institution may comprise time expended by the associate of the financial institution to manually verify the one or more items of information with a representative of an account holder of the financial institution that is associated with the commercial financial transaction that involves the exception to the straight-through processing procedure of the financial institution.

In some embodiments, the computing platform may generate a report comprising at least a portion of the plurality of records stored in the memory that correspond to commercial financial transactions that involve exceptions to a straight-through processing procedure of the financial institution, and may communicate the report comprising the at least a portion of the plurality of records stored in the memory that correspond to commercial financial transactions that involve exceptions to a straight-through processing procedure of the financial institution to a computing device associated with a manager of the financial institution. In some embodiments, the at least a portion of the plurality of records may be sorted by account numbers of the financial institution. Each account number of the account numbers may be associated with a record of said at least a portion of the plurality of records. Additionally or alternatively, the report may indicate the amount of time expended by the associate of the financial institution to process the commercial financial transaction that involves the exception to the straight-through processing procedure of the financial institution. In some embodiments, each record of said at least a portion of the plurality of records may comprise a value indicating an amount of time expended by an associate of the financial institution to process a commercial financial transaction that involves an exception to a straight-through processing procedure of the financial institution that is associated with the record, and each record of said at least a portion of the plurality of records may be ordered within the report with respect to each other record of said at least a portion of the plurality of records based on its respective value indicating the amount of time expended by the associate of the financial institution to process the commercial financial transaction that involves the exception to the straight-through processing procedure of the financial institution that is associated with the record.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for tracking processing of exceptions to straight-through processing procedures in accordance with one or more example embodiments;

FIGS. 4A, 4B, 4C, 4D, and 4E depict an illustrative event sequence for tracking processing of exceptions to straight-through processing procedures in accordance with one or more example embodiments;

FIG. 5 depicts an example graphical user interface for tracking processing of exceptions to straight-through processing procedures in accordance with one or more example embodiments; and

FIG. 6 depicts an illustrative method for tracking processing of exceptions to straight-through processing procedures in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

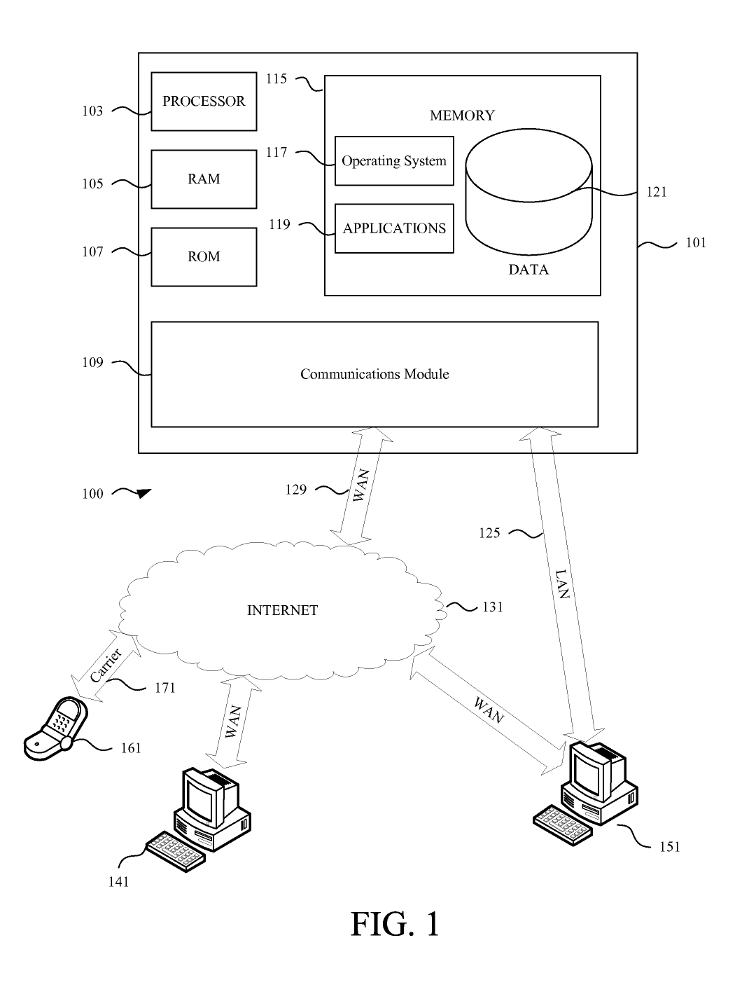

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

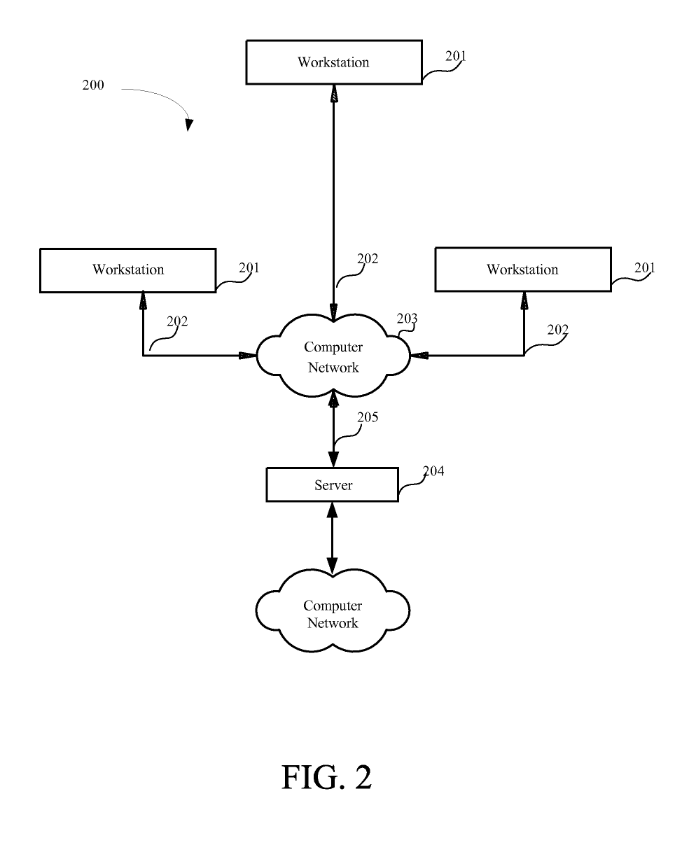

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

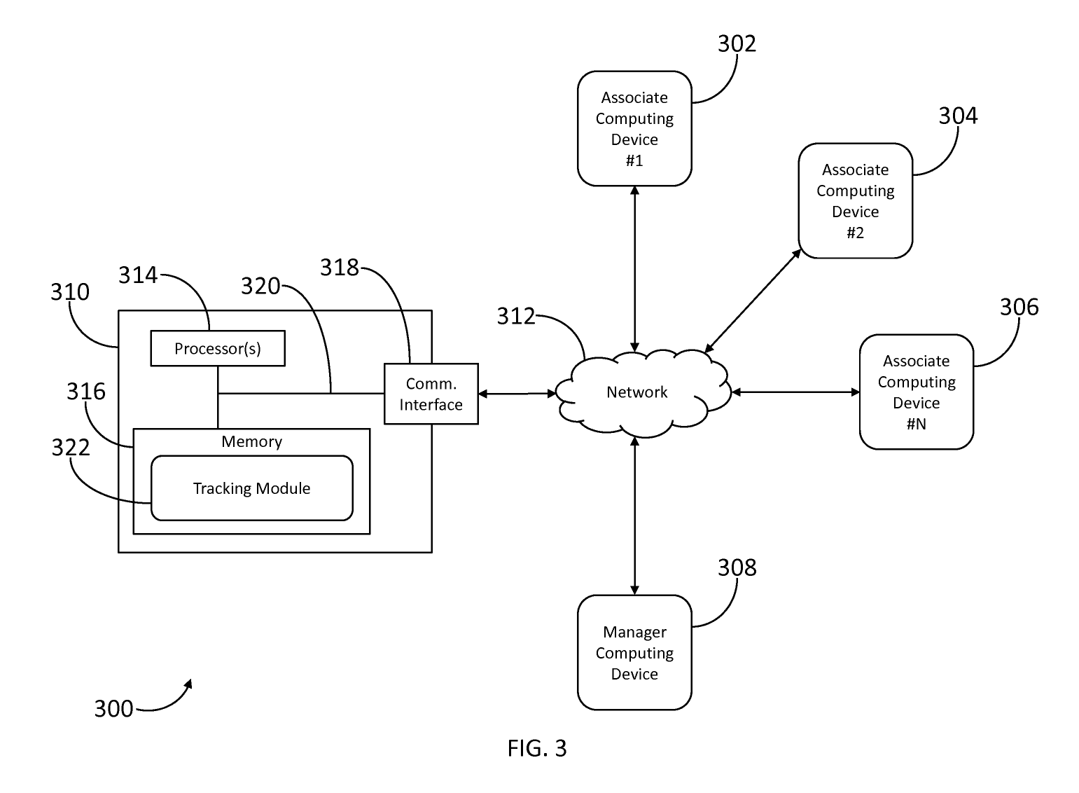

FIG. 3 depicts an illustrative computing environment for tracking processing of exceptions to straight-through processing procedures in accordance with one or more example embodiments. Referring to FIG. 3, computing environment 300 may include one or more computing devices associated with an organization (e.g., a financial institution, corporation, government entity, university, or the like). For example, computing environment 300 may include associate computing devices 302, 304, and 306, and manager computing device 308. Associate computing devices 302, 304, and 306, and manager computing device 308 may be any type of computing device capable of receiving a user interface, receiving input via the user interface, and communicating the received input to one or more other computing devices. For example, associate computing device 302, 304, and/or 306 and/or manager computing device 308 may be a desktop computer, laptop computer, tablet computer, smart phone, or the like. Computing environment 300 may also include computing platform 310 and network 312. Network 312 may interconnect one or more of associate computing devices 302, 304, and 306, manager computing device 308, and/or computing platform 310. Network 312 may include one or more sub-networks (e.g., LANs, WANs, or the like).

Computing platform 310 may include one or more processor(s) 314, memory 316, communication interface 318, and data bus 320. Data bus 320 may interconnect processor(s) 314, memory 316, and/or communication interface 318. Communication interface 318 may be a network interface configured to support communication between computing platform 310 and network 312, or one or more sub-networks thereof. Memory 316 may include one or more program modules comprising instructions that when executed by processor(s) 314 cause computing platform 310 to perform one or more functions described herein. For example, memory 316 may include tracking module 322. As will be described in greater detail below, tracking module 322 may comprise instructions that when executed by processor(s) 314 cause computing platform 310 to identify a record corresponding to a commercial financial transaction that involves an exception to a straight-through processing procedure of a financial institution from amongst a plurality of records stored in memory 316 that correspond to commercial financial transactions that involve exceptions to a straight-through processing procedure of the financial institution.

The instructions may further cause computing platform 310 to generate a graphical user interface for the commercial financial transaction that involves the exception to the straight-through processing procedure of the financial institution. The graphical user interface may comprise data from a plurality of fields of the record corresponding to the commercial financial transaction that involves the exception to the straight-through processing procedure of the financial institution and one or more graphical user interface elements for controlling a timer configured to track an amount of time expended by an associate of the financial institution to process the commercial financial transaction that involves the exception to the straight-through processing procedure of the financial institution. The instructions may further cause computing platform 310 to identify an associate of the financial institution to process the commercial financial transaction that involves the exception to the straight-through processing procedure of the financial institution (e.g., an associate utilizing associate computing device 302) and to communicate (e.g., via communication interface 318) the graphical user interface for the commercial financial transaction that involves the exception to the straight-through processing procedure of the financial institution to a computing device associated with the associate of the financial institution (e.g., associate computing device 302).

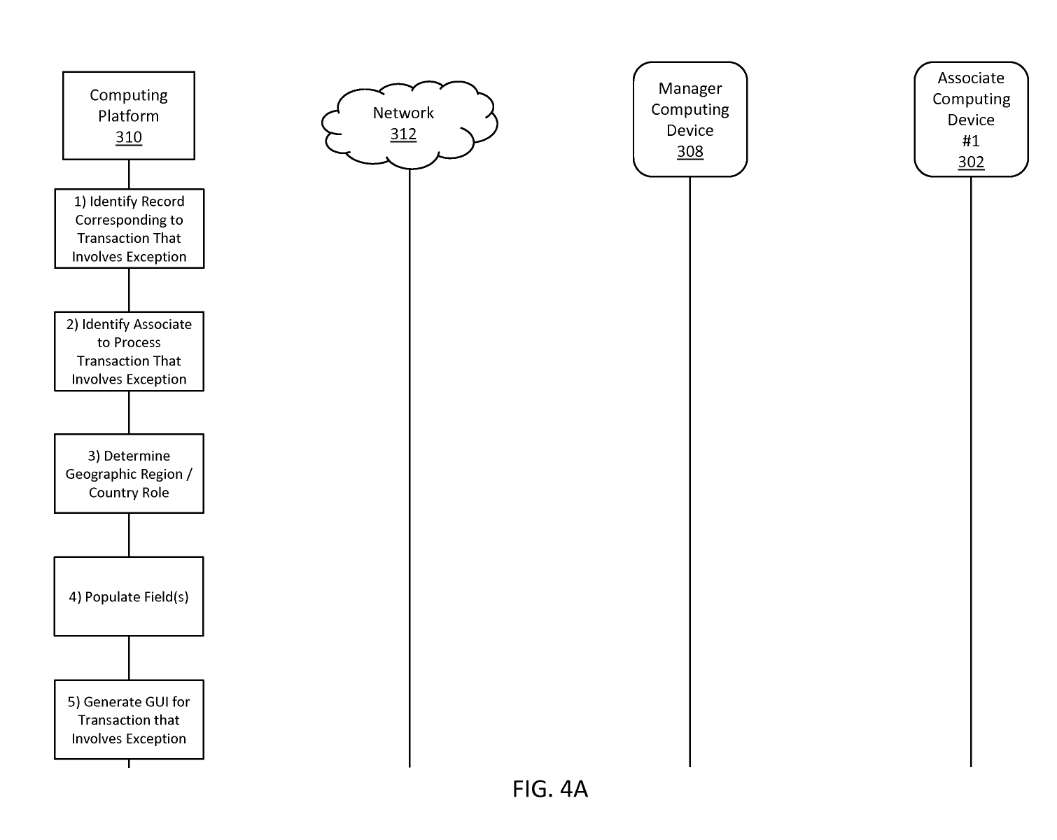

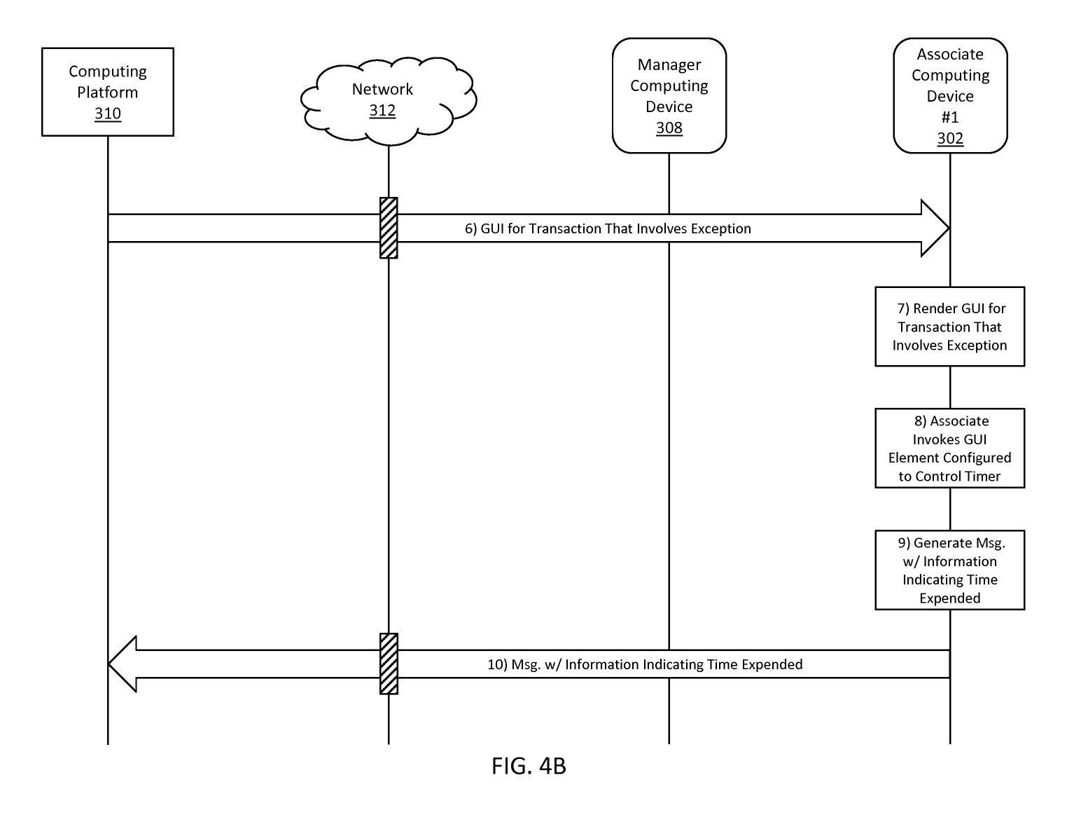

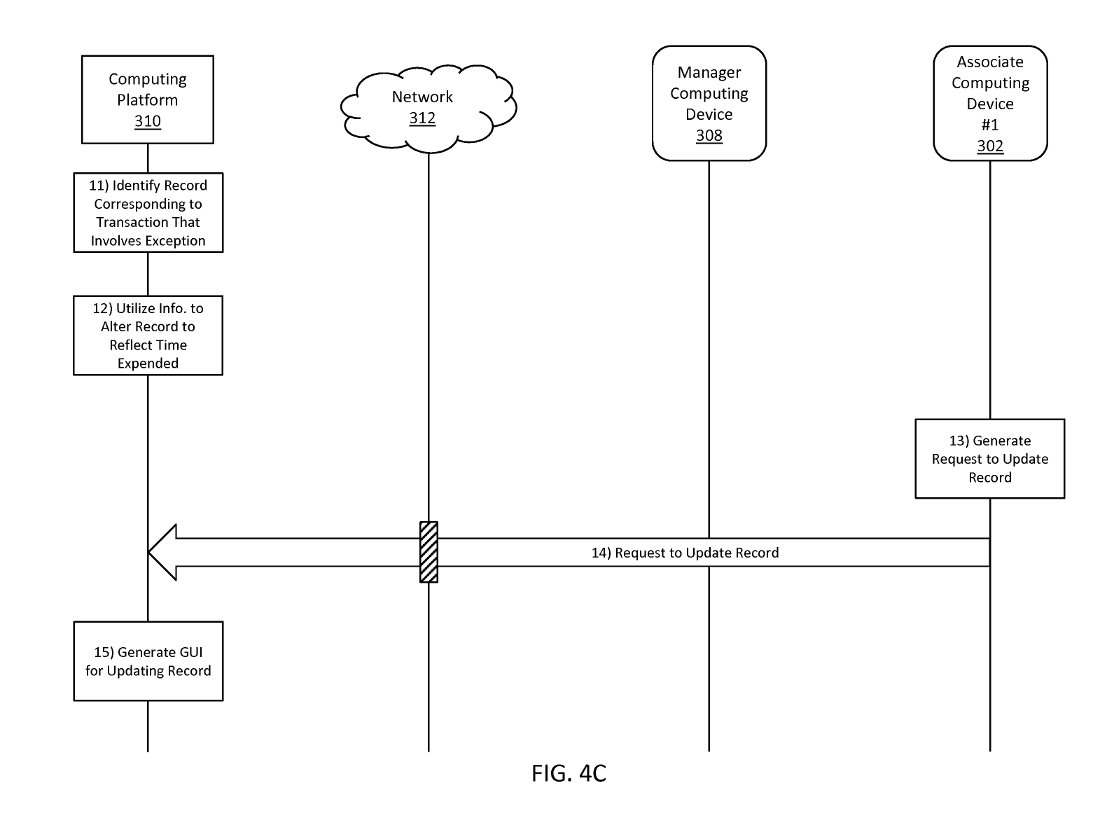

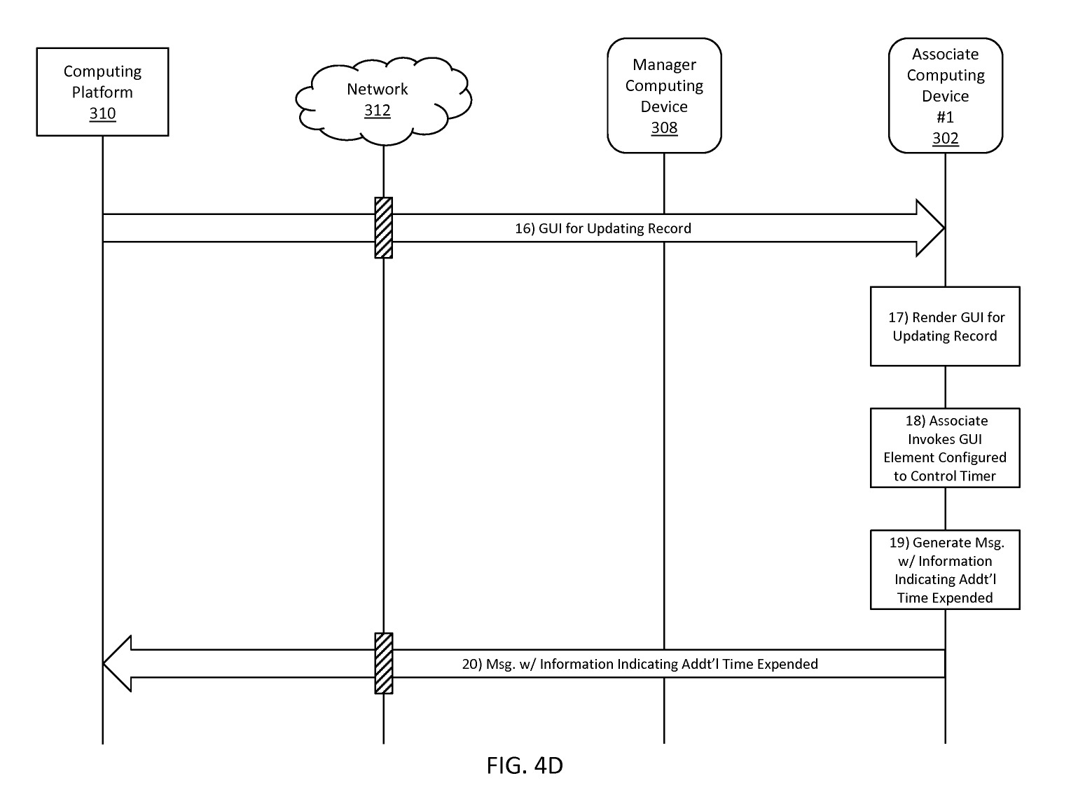

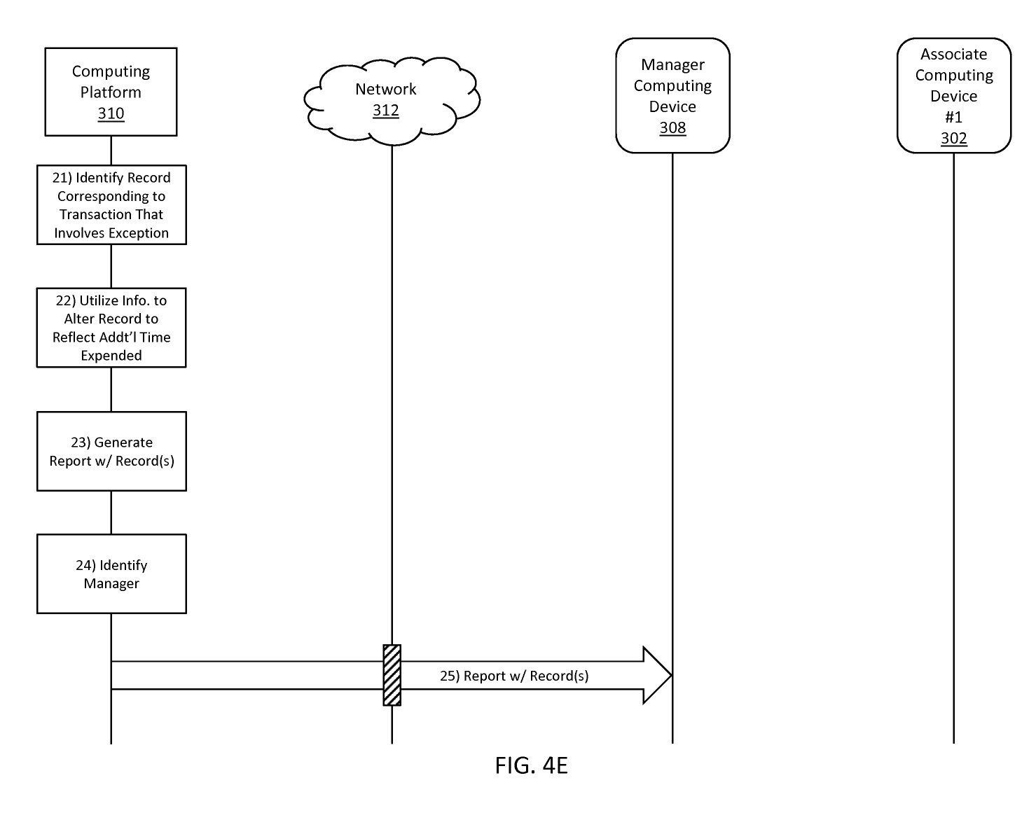

FIGS. 4A, 4B, 4C, 4D, and 4E depict an illustrative event sequence for tracking processing of exceptions to straight-through processing procedures in accordance with one or more example embodiments. Referring to FIG. 4A, at step 1, computing platform 310 may identify a record corresponding to a commercial financial transaction that involves an exception to a straight-through processing procedure of a financial institution from amongst a plurality of records stored in memory 316 that correspond to commercial financial transactions that involve exceptions to a straight-through processing procedure of the financial institution. For example, memory 316 may comprise a plurality of records that correspond to commercial financial transactions that involve exceptions to a straight-through processing procedure of a financial institution associated with computing environment 300 (e.g., transactions that require human intervention to complete processing), and computing platform 310 may identify a record corresponding to a commercial financial transaction that involves an exception to a straight-through processing procedure of the financial institution from amongst the plurality of records stored in memory 316 (e.g., the next record in a queue of pending commercial financial transactions that require human intervention to complete processing). At step 2, computing platform 310 may identify an associate of the financial institution to process the commercial financial transaction that involves the exception to the straight-through processing procedure of the financial institution. For example, computing platform 310 may identify an associate utilizing associate computing device 302 to process the commercial financial transaction that involves the exception to the straight-through processing procedure of the financial institution (e.g., based on the associate's current workload, historical performance, and/or suitability to process the commercial financial transaction that involves the exception to the straight-through processing procedure of the financial institution). At step 3, computing platform 310 may determine a geographic region associated with the commercial financial transaction that involves the exception to the straight-through processing procedure of the financial institution and/or a country role associated with the identified associate of the financial institution, and, at step 4, may populate (or prepopulate) at least a portion of a plurality of fields of the record corresponding to the commercial financial transaction that involves the exception to the straight-through processing procedure of the financial institution based on the geographic region associated with the commercial financial transaction that involves the exception to the straight-through processing procedure of the financial institution and/or the country role associated with the identified associate of the financial institution. For example, as will be described in greater detail below, the record corresponding to the commercial financial transaction that involves the exception to the straight-through processing procedure of the financial institution may include a plurality of fields (e.g., a customer field, an account number field, a transaction amount field, a source channel field, an exception type field, a product type field, a field indicating whether a second level of review is required, and/or, if a second level of review is required, a field indicating a second level reviewer), and computing platform 310 may populate (or prepopulate) one or more of said plurality of fields based on the geographic region associated with the commercial financial transaction that involves the exception to the straight-through processing procedure of the financial institution and/or the country role associated with the identified associate of the financial institution.

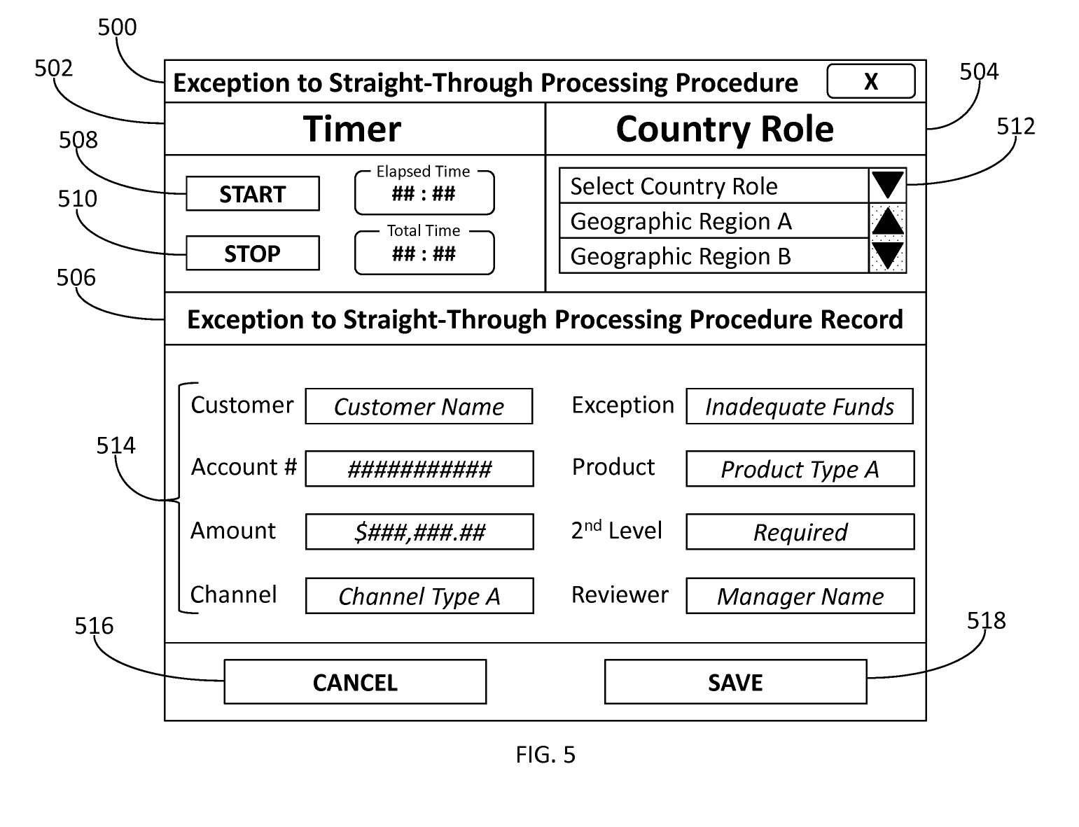

At step 5, computing platform 310 may generate a graphical user interface for the commercial financial transaction that involves the exception to the straight-through processing procedure of the financial institution. For example, computing platform 310 may generate a graphical user interface similar to graphical user interface 500 depicted in FIG. 5. Referring to FIG. 5, graphical user interface 500 may include timer portion 502, country role portion 504, and record portion 506. Timer portion 502 may include one or more timers configured to track one or more amounts of time (e.g., a current amount of elapsed time, a total amount of elapsed time, or the like) expended by one or more associates of the financial institution to process the commercial financial transaction that involves the exception to the straight-through processing procedure of the financial institution. In some embodiments, timer portion 502 may also include one or more user interface elements for controlling the timer(s) configured to track the amount(s) of time expended by associate(s) of the financial institution to process the commercial financial transaction that involves the exception to the straight-through processing procedure of the financial institution. For example, timer portion 502 may include start button 508 and stop button 510. Start button 508 may be configured to, when invoked, start one or more of the timer(s) configured to track the amount(s) of time expended by associate(s) of the financial institution to process the commercial financial transaction that involves the exception to the straight-through processing procedure of the financial institution. Similarly, stop button 510 may be configured to, when invoked, stop one or more of the timer(s) configured to track the amount(s) of time expended by associate(s) of the financial institution to process the commercial financial transaction that involves the exception to the straight-through processing procedure of the financial institution. Country role portion 504 may include a selectable option for an associate of the financial institution to indicate in which country role they are currently serving. For example, country role portion 504 may include selectable option 512, which may include a plurality of selectable options corresponding to various possible country roles an associate of the financial institution may be serving in at a particular time (e.g., geographic region A, geographic region B, or the like).

As indicated above, the record corresponding to the commercial financial transaction that involves the exception to the straight-through processing procedure of the financial institution may include a plurality of fields (e.g., a customer field, an account number field, a transaction amount field, a source channel field, an exception type field, a product type field, a field indicating whether a second level of review is required, and/or, if a second level of review is required, a field indicating a second level reviewer). Record portion 506 may include a plurality of data fields, which may include labels and/or corresponding values (or data) that correspond to each field for the record. For example, record portion 506 may include data fields 514. Graphical user interface 500 may also include one or more additional graphical user interface elements for processing the record corresponding to the commercial financial transaction that involves the exception to the straight-through processing procedure of the financial institution. For example, graphical user interface 500 may include cancel button 516 and save button 518. When invoked, cancel button 516 may close the graphical user interface for the commercial financial transaction that involves the exception to the straight-through processing procedure of the financial institution without committing or saving any changes made by the associate of the financial institution to one or more of data fields 514. Similarly, when invoked, save button 518 may close the graphical user interface for the commercial financial transaction that involves the exception to the straight-through processing procedure of the financial institution and commit or save any changes made by the associate of the financial institution to one or more of data fields 514.

Referring to FIG. 4B, at step 6, computing platform 310 may communicate (e.g., via communication interface 318) the graphical user interface for the commercial financial transaction that involves the exception to the straight-through processing procedure of the financial institution to a computing device associated with the identified associate of the financial institution. For example, computing platform 310 may communicate graphical user interface 500 (e.g., via network 312) to associate computing device 302). Associate computing device 302 may receive the graphical user interface for the commercial financial transaction that involves the exception to the straight-through processing procedure of the financial institution and, at step 7, may render the graphical user interface for the commercial financial transaction that involves the exception to the straight-through processing procedure of the financial institution. For example, associate computing device 302 may receive graphical user interface 500 from computing platform 310, and may render graphical user interface 500. At step 8, an associate of the financial institution utilizing associate computing device 302 may invoke a graphical user interface element of the graphical user interface for the commercial financial transaction that involves the exception to the straight-through processing procedure of the financial institution for controlling the timer(s) configured to track the amount(s) of time expended by the associate(s) of the financial institution to process the commercial financial transaction that involves the exception to the straight-through processing procedure of the financial institution.

In some embodiments, the graphical user interface element for controlling the timer(s) configured to track the amount(s) of time expended by the associate(s) of the financial institution to process the commercial financial transaction that involves the exception to the straight-through processing procedure of the financial institution may comprise a graphical user interface element visibly labeled as being configured for controlling the timer configured to track the amount(s) of time expended by the associate(s) of the financial institution to process the commercial financial transaction that involves the exception to the straight-through processing procedure of the financial institution. For example, the associate of the financial institution utilizing associate computing device 302 may invoke start button 508 or stop button 510. In other embodiments, the graphical user interface element for controlling the timer(s) configured to track the amount(s) of time expended by the associate(s) of the financial institution to process the commercial financial transaction that involves the exception to the straight-through processing procedure of the financial institution may comprise a graphical user interface element associated with processing the commercial financial transaction that involves the exception to the straight-through processing procedure of the financial institution that is not visibly labeled as being configured for controlling the timer(s) configured to track the amount(s) of time expended by the associate(s) of the financial institution to process the commercial financial transaction that involves the exception to the straight-through processing procedure of the financial institution. For example, the associate of the financial institution utilizing associate computing device 302 may invoke cancel button 516 or save button 518.

Responsive to the graphical user interface element for controlling the timer configured to track the amount(s) of time expended by the associate(s) of the financial institution to process the commercial financial transaction that involves the exception to the straight-through processing procedure of the financial institution being invoked, at step 9, associate computing device 302 may generate a message comprising information indicating the amount of time expended by the associate of the financial institution to process the commercial financial transaction that involves the exception to the straight-through processing procedure of the financial institution. In some embodiments, the exception to the straight-through processing procedure of the financial institution may comprise a determination that an account of the financial institution associated with the commercial financial transaction that involves the exception to the straight-through processing procedure of the financial institution does not have adequate funds to complete the commercial financial transaction that involves the exception to the straight-through processing procedure of the financial institution. In such embodiments, the amount of time expended by the associate of the financial institution to process the commercial financial transaction that involves the exception to the straight-through processing procedure of the financial institution may comprise time expended by the associate of the financial institution to arrange for the adequate funds to complete the commercial financial transaction that involves the exception to the straight-through processing procedure of the financial institution to be transferred from another account of the financial institution. Additionally or alternatively, the amount of time expended by the associate of the financial institution to process the commercial financial transaction that involves the exception to the straight-through processing procedure of the financial institution may comprise time expended by the associate of the financial institution to delay processing of the commercial financial transaction that involves the exception to the straight-through processing procedure of the financial institution until one or more outstanding deposits that would provide the adequate funds to complete the commercial financial transaction that involves the exception to the straight-through processing procedure of the financial institution have been deposited in the account of the financial institution associated with the commercial financial transaction that involves the exception to the straight-through processing procedure of the financial institution.

In some embodiments, the exception to the straight-through processing procedure of the financial institution may comprise a determination that one or more items of information associated with the commercial financial transaction that involves the exception to the straight-through processing procedure of the financial institution require manual verification to complete the commercial financial transaction that involves the exception to the straight-through processing procedure of the financial institution. In such embodiments, the amount of time expended by the associate of the financial institution to process the commercial financial transaction that involves the exception to the straight-through processing procedure of the financial institution may comprise time expended by the associate of the financial institution to manually verify the one or more items of information with a representative of an account holder of the financial institution that is associated with the commercial financial transaction that involves the exception to the straight-through processing procedure of the financial institution.

At step 10, associate computing device 302 may communicate (e.g., via network 312) the message comprising the information indicating the amount of time expended by the associate of the financial institution to process the commercial financial transaction that involves the exception to the straight-through processing procedure of the financial institution to computing platform 310. Computing platform 310 may receive (e.g., via communication interface 318) the message comprising the information indicating the amount of time expended by the associate of the financial institution to process the commercial financial transaction that involves the exception to the straight-through processing procedure of the financial institution from associate computing device 302, and, referring to FIG. 4C, at step 11, may identify the record corresponding to the commercial financial transaction that involves the exception to the straight-through processing procedure of the financial institution from amongst the plurality of records stored in memory 316 that correspond to commercial financial transactions that involve exceptions to a straight-through processing procedure of the financial institution. At step 12, computing platform 310 may utilize the information indicating the amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution to process the commercial financial transaction that involves the exception to the straight-through processing procedure of the financial institution (e.g., the time expended by the associate of the financial institution to arrange for the adequate funds to complete the commercial financial transaction that involves the exception to the straight-through processing procedure of the financial institution to be transferred from another account of the financial institution, the time expended by the associate of the financial institution to delay processing of the commercial financial transaction that involves the exception to the straight-through processing procedure of the financial institution until one or more outstanding deposits that would provide the adequate funds to complete the commercial financial transaction that involves the exception to the straight-through processing procedure of the financial institution have been deposited in the account of the financial institution associated with the commercial financial transaction that involves the exception to the straight-through processing procedure of the financial institution, and/or the time expended by the associate of the financial institution to manually verify the one or more items of information with a representative of an account holder of the financial institution that is associated with the commercial financial transaction that involves the exception to the straight-through processing procedure of the financial institution).

At step 13, associate computing device 302 may generate a request to update the record corresponding to the commercial financial transaction that involves the exception to the straight-through processing procedure of the financial institution. For example, an associate utilizing associate computing device 302 may desire to make one or more changes to field(s) of the record corresponding to the commercial financial transaction that involves the exception to the straight-through processing procedure of the financial institution and may request to update the record corresponding to the commercial financial transaction that involves the exception to the straight-through processing procedure of the financial institution. At step 14, associate computing device 302 may communicate (e.g., via network 312) the request to update the record corresponding to the commercial financial transaction that involves the exception to the straight-through processing procedure of the financial institution to computing platform 310. Computing platform 310 may receive the request to update the record corresponding to the commercial financial transaction that involves the exception to the straight-through processing procedure of the financial institution, and, responsive to receiving the request to update the record corresponding to the commercial financial transaction that involves the exception to the straight-through processing procedure of the financial institution, at step 15, computing platform 310 may generate a graphical user interface for updating the record corresponding to the commercial financial transaction that involves the exception to the straight-through processing procedure of the financial institution. The graphical user interface for updating the record (e.g., graphical user interface 500) may comprise data from a plurality of fields of the record corresponding to the commercial financial transaction that involves the exception to the straight-through processing procedure of the financial institution (e.g., data fields 514), the amount of time expended by the associate of the financial institution to process the commercial financial transaction that involves the exception to the straight-through processing procedure of the financial institution (e.g., displayed on one or more timer(s) of timer portion 502), and one or more graphical user interface elements for controlling a timer configured to track an additional amount of time expended by an associate of the financial institution to process the commercial financial transaction that involves the exception to the straight-through processing procedure of the financial institution (e.g., start button 508, stop button 510, cancel button 516, and/or save button 518).

Referring to FIG. 4D, at step 16, computing platform 310 may communicate (e.g., via communication interface 318 and network 312) the graphical user interface for updating the record corresponding to the commercial financial transaction that involves the exception to the straight-through processing procedure of the financial institution to associate computing device 302. Associate computing device 302 may receive the graphical user interface for updating the record corresponding to the commercial financial transaction that involves the exception to the straight-through processing procedure of the financial institution from computing platform 310, and, at step 17, may render the graphical user interface for updating the record corresponding to the commercial financial transaction that involves the exception to the straight-through processing procedure of the financial institution.

At step 18, an associate of the financial institution utilizing associate computing device 302 may invoke a graphical user interface element for controlling the timer(s) configured to track the additional amount(s) of time expended by the associate(s) of the financial institution to process the commercial financial transaction that involves the exception to the straight-through processing procedure of the financial institution (e.g., start button 508, stop button 510, cancel button 516, and/or save button 518), and, responsive to the graphical user interface element for controlling the timer(s) configured to track the additional amount(s) of time expended by the associate(s) of the financial institution to process the commercial financial transaction that involves the exception to the straight-through processing procedure of the financial institution being invoked, at step 19, associate computing device 302 may generate a message comprising information indicating the additional amount of time expended by the associate of the financial institution to process the commercial financial transaction that involves the exception to the straight-through processing procedure of the financial institution and, at step 20, may communicate (e.g., via network 312) the message comprising the information indicating the additional amount of time expended by the associate of the financial institution to process the commercial financial transaction that involves the exception to the straight-through processing procedure of the financial institution to computing platform 310.

Computing platform 310 may receive (e.g., via communication interface 318) the message comprising the information indicating the additional amount of time expended by the associate of the financial institution to process the commercial financial transaction that involves the exception to the straight-through processing procedure of the financial institution from associate computing device 302, and, referring to FIG. 4E, at step 21, may identify the record corresponding to the commercial financial transaction that involves the exception to the straight-through processing procedure of the financial institution from amongst the plurality of records stored in memory 316 that correspond to commercial financial transactions that involve exceptions to a straight-through processing procedure of the financial institution. At step 22, computing platform 310 may utilize the information indicating the additional amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the additional amount of time expended by the associate of the financial institution to process the commercial financial transaction that involves the exception to the straight-through processing procedure of the financial institution (e.g., additional time expended by the associate of the financial institution to arrange for the adequate funds to complete the commercial financial transaction that involves the exception to the straight-through processing procedure of the financial institution to be transferred from another account of the financial institution, additional time expended by the associate of the financial institution to delay processing of the commercial financial transaction that involves the exception to the straight-through processing procedure of the financial institution until one or more outstanding deposits that would provide the adequate funds to complete the commercial financial transaction that involves the exception to the straight-through processing procedure of the financial institution have been deposited in the account of the financial institution associated with the commercial financial transaction that involves the exception to the straight-through processing procedure of the financial institution, and/or additional time expended by the associate of the financial institution to manually verify the one or more items of information with a representative of an account holder of the financial institution that is associated with the commercial financial transaction that involves the exception to the straight-through processing procedure of the financial institution).

At step 23, computing platform 310 may generate a report comprising at least a portion of the plurality of records stored in memory 316 that correspond to commercial financial transactions that involve exceptions to a straight-through processing procedure of the financial institution. In some embodiments, the at least a portion of the plurality of records may be sorted within the report by account numbers of the financial institution. Each account number of the account numbers may be associated with a record of said at least a portion of the plurality of records. Additionally or alternatively, the report may indicate the amount of time expended by the associate of the financial institution to process the commercial financial transaction that involves the exception to the straight-through processing procedure of the financial institution. In some embodiments, each record of said at least a portion of the plurality of records may comprise a value indicating an amount of time expended by an associate of the financial institution to process a commercial financial transaction that involves an exception to a straight-through processing procedure of the financial institution that is associated with the record, and each record of said at least a portion of the plurality of records may be ordered within the report with respect to each other record of said at least a portion of the plurality of records based on its respective value indicating the amount of time expended by the associate of the financial institution to process the commercial financial transaction that involves the exception to the straight-through processing procedure of the financial institution that is associated with the record. At step 24, computing platform 310 may identify one or more managers associated with one or more associates of the financial institution who expended time processing records included among the at least a portion of the plurality of records included in the report. For example, computing platform 310 may identify a manager associated with manager computing device 308 based on the expenditure of the associate utilizing associate computing device 302's time processing the commercial financial transaction that involves the exception to the straight-through processing procedure of the financial institution. At step 25, computing platform 310 may communicate the report comprising the at least a portion of the plurality of records stored in memory 316 that correspond to commercial financial transactions that involve exceptions to a straight-through processing procedure of the financial institution to one or more computing devices associated with the identified manager(s). For example, computing platform 310 may communicate (e.g., via communication interface 318 and network 312) the report comprising the at least a portion of the plurality of records stored in memory 316 that correspond to commercial financial transactions that involve exceptions to a straight-through processing procedure of the financial institution to manager computing device 308.

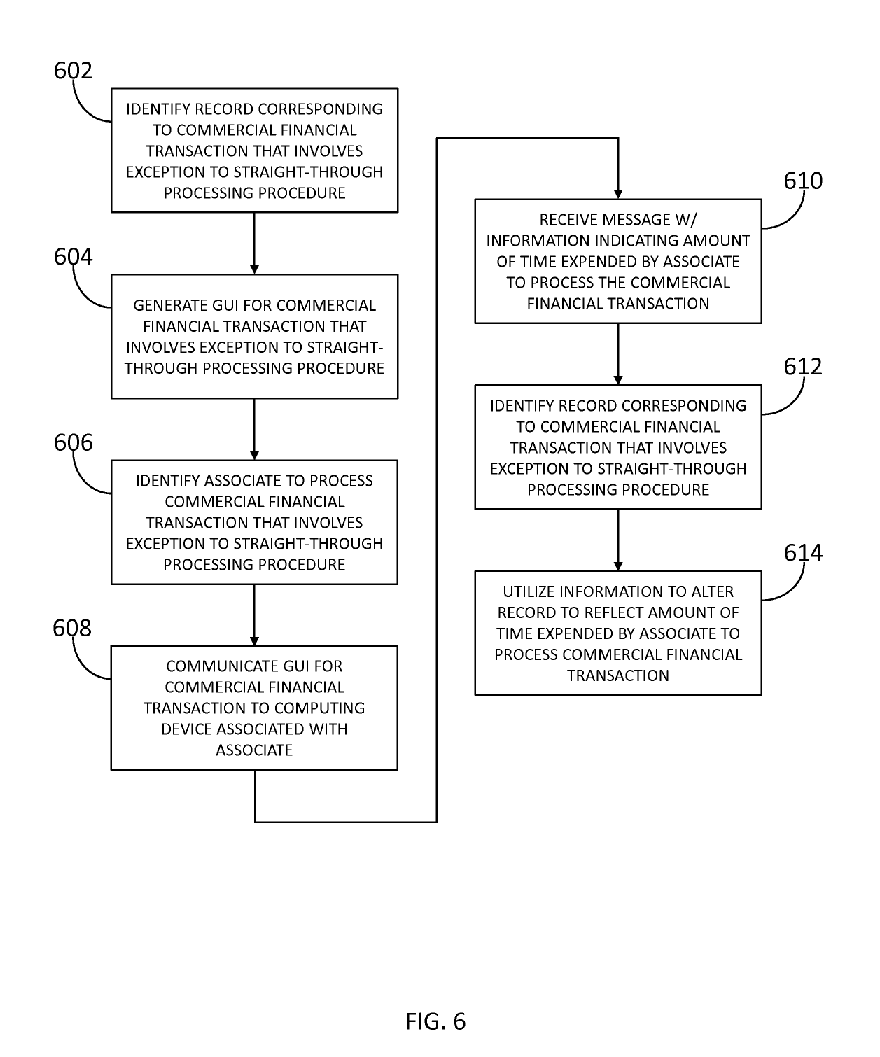

FIG. 6 depicts an illustrative method for tracking processing of exceptions to straight-through processing procedures in accordance with one or more example embodiments. Referring to FIG. 6, at step 602, a record corresponding to a commercial financial transaction that involves an exception to a straight-through processing procedure of a financial institution may be identified by a computing platform from amongst a plurality of records stored in a memory of the computing platform that correspond to commercial financial transactions that involve exceptions to a straight-through processing procedure of the financial institution. For example, computing platform 310 may identify a record corresponding to a commercial financial transaction that involves an exception to a straight-through processing procedure of a financial institution from amongst a plurality of records stored in memory 316 that correspond to commercial financial transactions that involve exceptions to a straight-through processing procedure of the financial institution. At step 604, a graphical user interface for the commercial financial transaction that involves the exception to the straight-through processing procedure of the financial institution may be generated by the computing platform. For example, computing platform 310 may generate graphical user interface 500. At step 606, an associate of the financial institution to process the commercial financial transaction that involves the exception to the straight-through processing procedure of the financial institution may be identified by the computing platform. For example, computing platform 310 may identify an associate of the financial institution utilizing associate computing device 302 to process the commercial financial transaction that involves the exception to the straight-through processing procedure of the financial institution. At step 608, the graphical user interface for the commercial financial transaction that involves the exception to the straight-through processing procedure of the financial institution may be communicated by the computing platform to a computing device associated with the associate of the financial institution. For example, computing platform 310 may communicate graphical user interface 500 to associate computing device 302.

At step 610, a message comprising information indicating an amount of time expended by the associate of the financial institution to process the commercial financial transaction that involves the exception to the straight-through processing procedure of the financial institution may be received by the computing platform from the computing device associated with the associate of the financial institution. For example, computing platform 310 may receive a message comprising information indicating an amount of time expended by the associate of the financial institution utilizing associate computing device 302 to process the commercial financial transaction that involves the exception to the straight-through processing procedure of the financial institution from associate computing device 302. At step 612, the record corresponding to the commercial financial transaction that involves the exception to the straight-through processing procedure of the financial institution may be identified by the computing platform from amongst the plurality of records stored in the memory that correspond to commercial financial transactions that involve exceptions to a straight-through processing procedure of the financial institution. For example, computing platform 310 may identify the record corresponding to the commercial financial transaction that involves the exception to the straight-through processing procedure of the financial institution from amongst the plurality of records stored in memory 316 that correspond to commercial financial transactions that involve exceptions to a straight-through processing procedure of the financial institution. At step 614, the computing platform may utilize the information indicating the amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution to process the commercial financial transaction that involves the exception to the straight-through processing procedure of the financial institution. For example, computing platform 310 may utilize the information indicating the amount of time expended by the associate of the financial institution utilizing associate computing device 302 to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution utilizing associate computing device 302 to process the commercial financial transaction that involves the exception to the straight-through processing procedure of the financial institution.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
identifying, by the at least one processor and from amongst a plurality of records stored in the memory that correspond to commercial financial transactions that involve exceptions to a straight-through processing procedure of a financial institution, a record corresponding to a commercial financial transaction that involves an exception to the straight-through processing procedure of the financial institution;
generating, by the at least one processor, a graphical user interface for the commercial financial transaction that involves the exception to the straight-through processing procedure of the financial institution, the graphical user interface comprising data from a plurality of fields of the record corresponding to the commercial financial transaction that involves the exception to the straight-through processing procedure of the financial institution and one or more graphical user interface elements for controlling a timer configured to track an amount of time expended by an associate of the financial institution to process the commercial financial transaction that involves the exception to the straight-through processing procedure of the financial institution;
identifying, by the at least one processor, an associate of the financial institution to process the commercial financial transaction that involves the exception to the straight-through processing procedure of the financial institution; and
communicating, via the communication interface and to a computing device associated with the associate of the financial institution, the graphical user interface for the commercial financial transaction that involves the exception to the straight-through processing procedure of the financial institution.

2. The method of claim 1, comprising:
receiving, by the computing device associated with the associate of the financial institution and from the computing platform, the graphical user interface for the commercial financial transaction that involves the exception to the straight-through processing procedure of the financial institution;
rendering, by the computing device associated with the associate of the financial institution, the graphical user interface for the commercial financial transaction that involves the exception to the straight-through processing procedure of the financial institution; and
responsive to a graphical user interface element of the one or more graphical user interface elements for controlling the timer configured to track the amount of time expended by the associate of the financial institution to process the commercial financial transaction that involves the exception to the straight-through processing procedure of the financial institution being invoked:
generating, by the computing device associated with the associate of the financial institution, a message comprising information indicating the amount of time expended by the associate of the financial institution to process the commercial financial transaction that involves the exception to the straight-through processing procedure of the financial institution; and
communicating, by the computing device associated with the associate of the financial institution and to the computing platform, the message comprising the information indicating the amount of time expended by the associate of the financial institution to process the commercial financial transaction that involves the exception to the straight-through processing procedure of the financial institution.

3. The method of claim 2, wherein the graphical user interface element of the one or more graphical user interface elements for controlling the timer configured to track the amount of time expended by the associate of the financial institution to process the commercial financial transaction that involves the exception to the straight-through processing procedure of the financial institution comprises a graphical user interface element visibly labeled as being configured for controlling the timer configured to track the amount of time expended by the associate of the financial institution to process the commercial financial transaction that involves the exception to the straight-through processing procedure of the financial institution.

4. The method of claim 2, wherein the graphical user interface element of the one or more graphical user interface elements for controlling the timer configured to track the amount of time expended by the associate of the financial institution to process the commercial financial transaction that involves the exception to the straight-through processing procedure of the financial institution comprises a graphical user interface element associated with processing the commercial financial transaction that involves the exception to the straight-through processing procedure of the financial institution and that is not visibly labeled as being configured for controlling the timer configured to track the amount of time expended by the associate of the financial institution to process the commercial financial transaction that involves the exception to the straight-through processing procedure of the financial institution.

5. The method of claim 2, comprising:
receiving, via the communication interface and from the computing device associated with the associate of the financial institution, the message comprising the information indicating the amount of time expended by the associate of the financial institution to process the commercial financial transaction that involves the exception to the straight-through processing procedure of the financial institution;
identifying, by the at least one processor and from amongst the plurality of records stored in the memory that correspond to commercial financial transactions that involve exceptions to a straight-through processing procedure of the financial institution, the record corresponding to the commercial financial transaction that involves the exception to the straight-through processing procedure of the financial institution; and
utilizing, by the at least one processor, the information indicating the amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution to process the commercial financial transaction that involves the exception to the straight-through processing procedure of the financial institution.

6. The method of claim 5, comprising:
receiving, via the communication interface and from the computing device associated with the associate of the financial institution, a request to update the record corresponding to the commercial financial transaction that involves the exception to the straight-through processing procedure of the financial institution; and
responsive to receiving the request to update the record corresponding to the commercial financial transaction that involves the exception to the straight-through processing procedure of the financial institution:
generating, by the at least one processor, a graphical user interface for updating the record corresponding to the commercial financial transaction that involves the exception to the straight-through processing procedure of the financial institution, the graphical user interface for updating the record comprising data from a plurality of fields of the record corresponding to the commercial financial transaction that involves the exception to the straight-through processing procedure of the financial institution, the amount of time expended by the associate of the financial institution to process the commercial financial transaction that involves the exception to the straight-through processing procedure of the financial institution, and one or more graphical user interface elements for controlling a timer configured to track an additional amount of time expended by an associate of the financial institution to process the commercial financial transaction that involves the exception to the straight-through processing procedure of the financial institution; and
communicating, via the communication interface and to the computing device associated with the associate of the financial institution, the graphical user interface for updating the record corresponding to the commercial financial transaction that involves the exception to the straight-through processing procedure of the financial institution.

7. The method of claim 6, comprising:
receiving, by the computing device associated with the associate of the financial institution and from the computing platform, the graphical user interface for updating the record corresponding to the commercial financial transaction that involves the exception to the straight-through processing procedure of the financial institution;
rendering, by the computing device associated with the associate of the financial institution, the graphical user interface for updating the record corresponding to the commercial financial transaction that involves the exception to the straight-through processing procedure of the financial institution; and
responsive to a graphical user interface element of the one or more graphical user interface elements for controlling the timer configured to track the additional amount of time expended by the associate of the financial institution to process the commercial financial transaction that involves the exception to the straight-through processing procedure of the financial institution being invoked:
generating, by the computing device associated with the associate of the financial institution, a message comprising information indicating the additional amount of time expended by the associate of the financial institution to process the commercial financial transaction that involves the exception to the straight-through processing procedure of the financial institution; and
communicating, by the computing device associated with the associate of the financial institution and to the computing platform, the message comprising the information indicating the additional amount of time expended by the associate of the financial institution to process the commercial financial transaction that involves the exception to the straight-through processing procedure of the financial institution.

8. The method of claim 7, comprising:
receiving, via the communication interface and from the computing device associated with the associate of the financial institution, the message comprising the information indicating the additional amount of time expended by the associate of the financial institution to process the commercial financial transaction that involves the exception to the straight-through processing procedure of the financial institution;
identifying, by the at least one processor and from amongst the plurality of records stored in the memory that correspond to commercial financial transactions that involve exceptions to a straight-through processing procedure of the financial institution, the record corresponding to the commercial financial transaction that involves the exception to the straight-through processing procedure of the financial institution; and
utilizing, by the at least one processor, the information indicating the additional amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the additional amount of time expended by the associate of the financial institution to process the commercial financial transaction that involves the exception to the straight-through processing procedure of the financial institution.

9. The method of claim 1, comprising:
determining, by the at least one processor, a geographic region associated with the commercial financial transaction that involves the exception to the straight-through processing procedure of the financial institution; and
populating, by the at least one processor and based on the geographic region associated with the commercial financial transaction that involves the exception to the straight-through processing procedure of the financial institution, at least a portion of the plurality of fields of the record corresponding to the commercial financial transaction that involves the exception to the straight-through processing procedure of the financial institution.

10. The method of claim 1, wherein the exception to the straight-through processing procedure of the financial institution comprises a determination that an account of the financial institution associated with the commercial financial transaction that involves the exception to the straight-through processing procedure of the financial institution does not have adequate funds to complete the commercial financial transaction that involves the exception to the straight-through processing procedure of the financial institution, and wherein the amount of time expended by the associate of the financial institution to process the commercial financial transaction that involves the exception to the straight-through processing procedure of the financial institution comprises time expended by the associate of the financial institution to arrange for the adequate funds to complete the commercial financial transaction that involves the exception to the straight-through processing procedure of the financial institution to be transferred from another account of the financial institution.

11. The method of claim 1, wherein the exception to the straight-through processing procedure of the financial institution comprises a determination that an account of the financial institution associated with the commercial financial transaction that involves the exception to the straight-through processing procedure of the financial institution does not have adequate funds to complete the commercial financial transaction that involves the exception to the straight-through processing procedure of the financial institution, and wherein the amount of time expended by the associate of the financial institution to process the commercial financial transaction that involves the exception to the straight-through processing procedure of the financial institution comprises time expended by the associate of the financial institution to delay processing of the commercial financial transaction that involves the exception to the straight-through processing procedure of the financial institution until one or more outstanding deposits that would provide the adequate funds to complete the commercial financial transaction that involves the exception to the straight-through processing procedure of the financial institution have been deposited in the account of the financial institution associated with the commercial financial transaction that involves the exception to the straight-through processing procedure of the financial institution.

12. The method of claim 1, wherein the exception to the straight-through processing procedure of the financial institution comprises a determination that one or more items of information associated with the commercial financial transaction that involves the exception to the straight-through processing procedure of the financial institution require manual verification to complete the commercial financial transaction that involves the exception to the straight-through processing procedure of the financial institution, and wherein the amount of time expended by the associate of the financial institution to process the commercial financial transaction that involves the exception to the straight-through processing procedure of the financial institution comprises time expended by the associate of the financial institution to manually verify the one or more items of information with a representative of an account holder of the financial institution that is associated with the commercial financial transaction that involves the exception to the straight-through processing procedure of the financial institution.

13. The method of claim 1, comprising:
generating, by the at least one processor, a report comprising at least a portion of the plurality of records stored in the memory that correspond to commercial financial transactions that involve exceptions to a straight-through processing procedure of the financial institution, said at least a portion of the plurality of records being sorted by account numbers of the financial institution, each account number of said account numbers being associated with a record of said at least a portion of the plurality of records, and said report indicating the amount of time expended by the associate of the financial institution to process the commercial financial transaction that involves the exception to the straight-through processing procedure of the financial institution;
identifying, by the at least one processor, a manager of the associate of the financial institution; and
communicating, via the communication interface and to a computing device associated with the manager of the associate of the financial institution, the report comprising the at least a portion of the plurality of records stored in the memory that correspond to commercial financial transactions that involve exceptions to a straight-through processing procedure of the financial institution.

14. The method of claim 1, comprising:
generating, by the at least one processor, a report comprising at least a portion of the plurality of records stored in the memory that correspond to commercial financial transactions that involve exceptions to a straight-through processing procedure of the financial institution, each record of said at least a portion of the plurality of records comprising a value indicating an amount of time expended by an associate of the financial institution to process a commercial financial transaction that involves an exception to a straight-through processing procedure of the financial institution that is associated with the record, and each record of said at least a portion of the plurality of records being ordered within the report with respect to each other record of said at least a portion of the plurality of records based on its respective value indicating the amount of time expended by the associate of the financial institution to process the commercial financial transaction that involves the exception to the straight-through processing procedure of the financial institution that is associated with the record; and
communicating, via the communication interface and to a computing device associated with a manager of the financial institution, the report comprising the at least a portion of the plurality of records stored in the memory that correspond to commercial financial transactions that involve exceptions to a straight-through processing procedure of the financial institution.

15. An apparatus, comprising:
at least one processor;
a communication interface; and
a memory storing instructions that when executed by the at least one processor cause the apparatus to:
identify, from amongst a plurality of records stored in the memory that correspond to commercial financial transactions that involve exceptions to a straight-through processing procedure of a financial institution, a record corresponding to a commercial financial transaction that involves an exception to the straight-through processing procedure of the financial institution;
generate a graphical user interface for the commercial financial transaction that involves the exception to the straight-through processing procedure of the financial institution, the graphical user interface comprising data from a plurality of fields of the record corresponding to the commercial financial transaction that involves the exception to the straight-through processing procedure of the financial institution and one or more graphical user interface elements for controlling a timer configured to track an amount of time expended by an associate of the financial institution to process the commercial financial transaction that involves the exception to the straight-through processing procedure of the financial institution;
identify an associate of the financial institution to process the commercial financial transaction that involves the exception to the straight-through processing procedure of the financial institution;
communicate, via the communication interface and to a computing device associated with the associate of the financial institution, the graphical user interface for the commercial financial transaction that involves the exception to the straight-through processing procedure of the financial institution;
receive, via the communication interface and from the computing device associated with the associate of the financial institution, a message comprising information indicating the amount of time expended by the associate of the financial institution to process the commercial financial transaction that involves the exception to the straight-through processing procedure of the financial institution;
identify, from amongst the plurality of records stored in the memory that correspond to commercial financial transactions that involve exceptions to a straight-through processing procedure of the financial institution, the record corresponding to the commercial financial transaction that involves the exception to the straight-through processing procedure of the financial institution; and
utilize the information indicating the amount of time expended by the associate of the financial institution to process the commercial financial transaction that involves the exception to the straight-through processing procedure of the financial institution to alter the record corresponding to the commercial financial transaction that involves the exception to the straight-through processing procedure of the financial institution to reflect the amount of time expended by the associate of the financial institution to process the commercial financial transaction that involves the exception to the straight-through processing procedure of the financial institution.

16. The apparatus of claim 15, wherein at least one graphical user interface element of the one or more graphical user interface elements for controlling the timer configured to track the amount of time expended by the associate of the financial institution to process the commercial financial transaction that involves the exception to the straight-through processing procedure of the financial institution comprises a graphical user interface element visibly labeled as being configured for controlling the timer configured to track the amount of time expended by the associate of the financial institution to process the commercial financial transaction that involves the exception to the straight-through processing procedure of the financial institution.

17. The apparatus of claim 15, wherein at least one graphical user interface element of the one or more graphical user interface elements for controlling the timer configured to track the amount of time expended by the associate of the financial institution to process the commercial financial transaction that involves the exception to the straight-through processing procedure of the financial institution comprises a graphical user interface element associated with processing the commercial financial transaction that involves the exception to the straight-through processing procedure of the financial institution and that is not visibly labeled as being configured for controlling the timer configured to track the amount of time expended by the associate of the financial institution to process the commercial financial transaction that involves the exception to the straight-through processing procedure of the financial institution.

18. One or more non-transitory computer-readable media having instructions stored thereon, that when executed by one or more computers, cause the one or more computers to:
identify, from amongst a plurality of records that correspond to commercial financial transactions that involve exceptions to a straight-through processing procedure of a financial institution, a record corresponding to a commercial financial transaction that involves an exception to the straight-through processing procedure of the financial institution;
generate a graphical user interface for the commercial financial transaction that involves the exception to the straight-through processing procedure of the financial institution, the graphical user interface comprising data from a plurality of fields of the record corresponding to the commercial financial transaction that involves the exception to the straight-through processing procedure of the financial institution and one or more graphical user interface elements for controlling a timer configured to track an amount of time expended by an associate of the financial institution to process the commercial financial transaction that involves the exception to the straight-through processing procedure of the financial institution;
identify an associate of the financial institution to process the commercial financial transaction that involves the exception to the straight-through processing procedure of the financial institution;
communicate, to a computing device associated with the associate of the financial institution, the graphical user interface for the commercial financial transaction that involves the exception to the straight-through processing procedure of the financial institution;
generate a report comprising at least a portion of the plurality of records that correspond to commercial financial transactions that involve exceptions to a straight-through processing procedure of the financial institution; and
communicate, to a computing device associated with a manager of the financial institution, the report comprising the at least a portion of the plurality of records that correspond to commercial financial transactions that involve exceptions to a straight-through processing procedure of the financial institution.

19. The one or more non-transitory computer readable media of claim 18, wherein said at least a portion of the plurality of records is sorted by account numbers of the financial institution, each account number of said account numbers being associated with a record of said at least a portion of the plurality of records, and wherein said report indicates the amount of time expended by the associate of the financial institution to process the commercial financial transaction that involves the exception to the straight-through processing procedure of the financial institution.

20. The one or more non-transitory computer readable media of claim 18, wherein each record of said at least a portion of the plurality of records comprises a value indicating an amount of time expended by an associate of the financial institution to process a commercial financial transaction that involves an exception to a straight-through processing procedure of the financial institution that is associated with the record, and each record of said at least a portion of the plurality of records is ordered within the report with respect to each other record of said at least a portion of the plurality of records based on its respective value indicating the amount of time expended by the associate of the financial institution to process the commercial financial transaction that involves the exception to the straight-through processing procedure of the financial institution that is associated with the record.
